(19) United States
(12) Patent Application Publication
(10) Pub. No.: US 2010/0201600 A1
(43) Pub. Date: Aug. 12, 2010

(54) SUPPORT FRAME FOR THE DISH OF A LARGE DISH ANTENNA

(76) Inventor: Stephen Kaneff, Australian Capital Territory (AU)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/671,310

(22) PCT Filed: Jul. 30, 2008
(86) PCT No.: PCT/AU2008/001092

§ 371 Date: Jan. 29, 2010

(30) Foreign Application Priority Data
Jul. 30, 2007 (AU) 2007904057

(51) Int. Cl. H01Q 1/12; H01Q 3/02

(52) U.S. Cl. 343/882; 343/878

(57) ABSTRACT

A support frame (20) for a large aperture dish (10) of a dish antenna is constructed as two arrays of rigid struts. The first array of struts is formed as a plurality of pyramidal strut assemblies. Each pyramidal strut assembly as eight rigid struts (5, 7; AB, AF, BG, FG, aA, aB, aG and aF) connected at their ends to five nodes (6, 8; A, B, G, F and a). Four of the nodes (6; A, B, G, F) and four of the struts (5; AB, AF, BG, FG) of each assembly form a rigid, rectangular base, the nodes of which establish mounting points for reflective or conductive elements (21) which form the dish (10) of the antenna. The fifth node (8; a) of each assembly, which is at the vertex of the pyramidal assembly, is away from—and behind—the dish (10) of the antenna.

### TECHNICAL FIELD

This invention concerns rigid dish antennas of the type used for radio telescopes, solar energy collectors, satellite communication and the like. More particularly, it concerns the structure for supporting the reflective or conductive dish of such an antenna.

### BACKGROUND TO THE INVENTION

Large dish antennas are used for receiving signals from satellites, energy from the sun and signals from stellar radio sources. They are also used to send beams of electromagnetic radiation into space (for example, for communication purposes). The rigid large dish of such antennas usually has a reflective or conductive surface which is a paraboloidal surface or a surface which is the shape of the cap of a sphere. A receiver or transmitter is located at the focal region of the dish surface (or its equivalent if the antenna includes a secondary reflector, in a manner analogous to a Cassegrain antenna). In the case of a receiving antenna, the dish focuses, or concentrates, the electromagnetic radiation that it receives, so that this radiation is incident on the receiver when the antenna is in use.

Large dish receiving antenna structures are normally rotated about two mutually perpendicular axes, to “track” a source of radiation (that is, to keep the pointing axis—also called the “line of sight”—of the dish directed to the source of radiation). Most commonly, one axis is horizontal and the other axis is vertical. This is the so-called “azimuth/altitude” tracking. A less common alternative is the “polar equatorial” tracking arrangement. In the case of a dish antenna for collecting solar energy, various design considerations have led to the azimuth/altitude tracking arrangement being the preferred tracking arrangement.

In a conventional dish antenna, the frame that supports the reflector dish (the support frame) is a complex structure. For example, the support frame may be an inverted geodesic dome or a series of hoops supported by a plurality of identical sub-frames which extend radially from below the centre of the dish. Such dish support frames are inherently weak structures, lacking in rigidity. Accordingly, they require complex bracing arrangements to give the support frame sufficient rigidity and strength to support a large reflective dish. And even with such bracing, if the dish reflector has a continuous surface (which is usually the case when the dish is used to receive and focus solar radiation), the reflector surface can distort to a significant extent when the antenna is subjected to even moderate wind loads. A direct consequence of such distortion of the dish reflective surface is a reduction in the cost effectiveness of an antenna used as a solar collector.

The cost effectiveness of the dish solar collector also depends on its ability to receive solar radiation when the sun is at or near the horizon. Since a change in the elevation of the pointing axis of a dish is effected by movement of the dish and its associated support frame about a horizontal axis, which is below the centre of the dish when the dish is pointing directly upwards, the axis of rotation of the dish structure must be at least half the vertical extent of the dish (measured when the dish has its pointing axis directed to the horizon). Accordingly, the horizontal axis of rotation of a dish antenna of the type used as a solar energy collector is almost invariably at the top of a tower. This means that when the dish is moved so that its line of sight is vertically above this axis, all of the dish surface is located well above the ground, where it is fully exposed to the wind. As noted above, even light wind loads will distort a reflector dish surface unless (a) the support frame of the dish is a rigid structure that includes a number of bracing members, and (b) the dish is constructed from a strong—and therefore heavy, and expensive—material (with the consequence that the handling capabilities of the ancillary equipment must be increased). If the dish is not made from a heavy, rigid material, it may be necessary to curtail the use of the antenna in strong winds to avoid the possibility that the dish will be damaged. Also, the integrity of the dish is more difficult to safeguard when the dish is exposed to extreme winds, even if it is not in use.

A further disadvantage of existing dish support frames is that, unless detailed, complex and time-consuming procedures are employed to fabricate the support frames, they are not constructed so that the points on the support frame (called “mounting points”) to which the dish surface is attached lie accurately on the envelope of the required surface of the dish. Thus, when assembling the antenna, and in particular when mounting the large reflective surface on the support frame, it is usually necessary to adjust the mounting of each portion of the reflecting surface to form the required surface shape of the dish.

The high cost of producing the conventional dish antenna, therefore, is due partly to the complex configuration of the support frame, partly to the nature of the materials that must be used for the dish, and partly to the amount of skilled labour that is required in the assembly and adjustment of the antenna structure.

A support frame that is more rigid than the conventional support frame for the dish of a dish antenna, and yet is of a relatively light-weight construction is described in the specification of European patent No. 0681747. That support frame has two arrays of rigid struts. The first array comprises a number of tetrahedral strut assemblies, with each assembly consisting of six struts connected at their ends to four nodes, to form a tetrahedral structure. Three nodes of each assembly are at the mounting points of the dish; the fourth node is remote from the envelope of the dish surface. Each strut assembly is edge connected to at least two adjacent strut assemblies. The second array of rigid struts is formed by connecting each of the fourth nodes to each adjacent fourth node.

The advantages of this construction of a support frame include the ability to build a strong, rigid, yet relatively light weight support frame for a dish antenna. In addition, the antenna design can be effected in a design office and the dish support frame can be assembled, accurately, on site. Furthermore, when assembled, the dish mounted on the support frame and the antenna can be used immediately (because in-field adjustments are unnecessary).

However, construction of such a support frame requires a complex node design, since the nodes receive multiple strut ends effectively meeting at acute angles. In addition, the need to use tetrahedral strut assemblies leads to the use of reflective surface elements which have a triangular shape, with corners having an acute angle which is approximately 60°, to be mounted on the mounting points of the support frame. This constraint increases the manufacturing and assembly complexity; it also causes the number of members in a given structure to be greater than the number needed for other support frame constructions. To avoid the need for acute-angled corners of the reflective elements, more complex dish elements, and more complex mounting fittings, are required, which further increases the cost of constructing the antenna.

Another cost-increasing factor when constructing an antenna having a large dish and a dish support frame as described in the specification of European patent No. 0681747 is the need to construct the support frame and the reflecting or conducting dish surface separately. The dish is then mounted on the support frame, which involves both time and effort, which can be avoided only by a substantially more complex design of both the tetrahedral strut assemblies and the reflective or conductive dish elements. It is, of course, important that each reflective or conductive dish surface element can be removed and replaced, if it is damaged.

### DISCLOSURE OF THE INVENTION

One object of the present invention is to provide a superior light weight, rigid, economically attractive, dish support frame for a large dish antenna, which avoids the shortcomings of the support frame having tetrahedral strut assemblies, which is described in the specification of European patent No. 0681747.

This objective is achieved by another support frame construction which has two arrays of rigid struts. In the present invention, however, the first array of struts is formed as a plurality of pyramidal strut assemblies. Each pyramidal strut assembly has eight rigid struts, connected at their ends to five nodes. Four of the nodes (which will be “base nodes”) and four of the struts of each assembly form a rigid, rectangular base for the pyramid. Each base node—itself or by an offset or protrusion from the node—provides a mounting point for the dish of the antenna. These mounting points lie on the curvilinear envelope of the dish. [Note: in this specification, the word “curvilinear”, means a shape that is not planar, but is curved in space. In the case of the dish of a solar energy collector—and in certain other types of antenna—the curvilinear envelope of the dish is preferably a paraboloid or the cap of a sphere.] The fifth node of each assembly, which has to be at the vertex (apex) of the pyramidal assembly, is necessarily away from (and behind) the dish of the antenna.

Each rectangular base is a rigid structure itself. Except in the trivial case of a support frame which has only two or three pyramidal strut assemblies (which will not be relevant to a support frame for a large dish antenna), the rectangular base of each pyramidal assembly is connected to the rectangular base of at least two adjacent pyramidal strut assemblies.

The second array of struts comprises a layer of rigid struts, each of which is connected to two of the fifth nodes—the vertex or apex nodes—of the pyramidal strut assemblies of the first array of struts.

In the first array of struts, the connection of the rigid bases of adjacent pyramidal strut assemblies is effected either by an edge connection arrangement (in which two pyramidal strut assemblies have a base strut and the nodes at the end of that strut in common), or by a corner connection arrangement (in which case, the two strut assemblies will have one base node in common).

If the connection of the rigid bases of adjacent pyramidal strut assemblies is exclusively by corner connection of the pyramidal assemblies, the least rigid support frame of the present invention will be produced. This support frame, constructed with the minimum number of struts, is suitable for the conditions of use that will be experienced by certain dish antennas. To increase the rigidity of this support frame, additional struts will be introduced. Those additional struts will be added to the first array in groups of four struts, each with an associated extra vertex or apex node, to form an additional pyramidal strut assembly in one of the spaces between the corner connected pyramidal strut assemblies. To do this, one end of each of the four struts of the group is held in a respective base node of the first array. The other end of each of these four struts will be connected to the extra, associated vertex node, which lies in the same curvilinear envelope as the other vertex nodes of the first array. Thus each group of four additional first array struts and their associated extra vertex node creates an additional pyramidal strut assembly that is edge connected to its adjacent pyramidal strut assemblies. At least one additional strut, and preferably at least two additional struts, of the second array will then be required to connect the extra vertex node to the second array of struts.

Each time an additional pyramidal strut assembly is included in the first array of struts in this manner, with its extra vertex node locked into the second array of struts, the rigidity of the support frame in the vicinity of the extra pyramidal strut assembly is increased. Therefore, if a limited number of additional pyramidal strut assemblies are added to a support frame, these additional strut assemblies will normally be included in the peripheral region of the support frame.

When every possible site in the first array of corner connected pyramidal strut assemblies for an additional pyramidal strut assembly has been filled with an additional pyramidal strut assembly (and each extra vertex node has been locked into the second array of struts), the rigid base of each pyramidal strut assembly of the first array will be edge connected to the rigid base of each adjacent pyramidal strut assembly. The first array of the dish support frame so created is the strongest form of the first or front array that can be constructed in accordance with the present invention.

Further strengthening of the dish support frame can be effected by careful choice of the arrangement of the layer of struts which form the second (or back) array of struts. In its basic form, the second array of struts comprises a layer of individual struts, with each strut of this layer having its ends connected to respective fifth (or vertex or apex) nodes of the first array. The only requirement of the second array is that every vertex node of the first array is connected to a strut of the second array. For a stronger dish support frame, the layer of struts of the second array will consist of a plurality of groups of struts, with each group of struts consisting of four struts, assembled as a rectangle, the corners of which are connected to respective vertex nodes of the first array of struts. If these groups of struts are rigid rectangular assemblies, and the strongest form of the first array has been adopted, a particularly strong dish support frame will be constructed. The distance between the rectangular bases of the pyramidal strut assemblies of the first array of struts and their associated vertex nodes—which determines the spacing between the dish (when mounted on the base nodes of the first array of struts) and the second array of struts—is also a factor which influences the strength and rigidity of the dish support frame.

Both the nature of the second array of struts and the spacing of the vertex nodes from the rectangular bases of the first array of struts are factors that engineers will consider when designing a dish support frame for a particular dish antenna.

From the foregoing, it will be seen that, according to the broadest form of the present invention, a support frame for a dish of a dish antenna comprises a first array of rigid struts and a second array of rigid struts, characterised in that:
(1) said first array comprises a first plurality of rigid strut assemblies, each of said strut assemblies consisting of eight struts, connected at their ends to five nodes; said five nodes consisting of four base nodes and a vertex node; each of said strut assemblies comprising a pyramidal assembly having
   (a) a rigid rectangular base comprising four of said eight struts connected to said four base nodes, said base nodes being at the corners of said rectangular base; said four base nodes comprising mounting points for said dish; and
   (b) each of the other four struts having one end connected to a respective base node and the other end thereof connected to its associated vertex node; each of said vertex nodes being spaced apart from its associated rectangular base;
(2) the base of each strut assembly of said first array is corner connected to the base of each adjacent strut assembly of said first array, said corner connection of the bases of two adjacent strut assemblies being effected by one corner base node of the first of said two strut assemblies being also one corner base node of the second of said two strut assemblies; and
(3) said second array comprises a second plurality of rigid struts in a single layer, each strut of said second array being connected between a vertex node of a pyramidal strut assembly of said first array and the vertex node of an adjacent pyramidal strut assembly.

For a more rigid support frame, at least one additional (or “infill”) pyramidal strut assembly is included in a space between the pyramidal strut assemblies of the corner connected pyramidal strut assemblies, the (or each) additional strut assembly comprising four additional struts; one end of each additional strut being connected to a respective corner base node of a pyramidal strut assembly; the other end of each additional strut being connected to an extra vertex node; said extra vertex node being positioned in said layer of struts of said second array; at least one additional strut being included in said second array to connect said extra vertex node to said second array of struts.

In the most preferred form of the present invention, a support frame for a dish of a dish antenna comprises a first array of rigid struts and a second array of rigid struts, characterised in that:
(1) said first array comprises a first plurality of rigid strut assemblies, each of said strut assemblies consisting of eight struts, connected at their ends to five nodes; said five nodes consisting of four base nodes and a vertex node; each of said strut assemblies comprising a pyramidal assembly having
   (a) a rigid rectangular base comprising four of said eight struts connected to said four base nodes, said base nodes being at the corners of said rectangular base; said four base nodes comprising mounting points for said dish; and
   (b) each of the other four struts having one end connected to a respective base node and the other end thereof connected to said vertex node; said vertex node being spaced apart from said rectangular base;
(2) the base of each strut assembly of said first array is edge connected to the base of each adjacent strut assembly of said first array, said edge connection of the bases of two adjacent strut assemblies being effected by one side strut of the base of a pyramidal strut assembly being also a side strut of the base of the adjacent pyramidal strut assembly, and the base nodes at the ends of said one side strut the first of said adjacent strut assemblies being also the base nodes at the ends of said one side strut of the second of said adjacent strut assemblies; and
(3) said second array comprises a second plurality of struts in a single layer, each strut of said second array being connected between a vertex node of a first strut assembly of said first array and the vertex node of a strut assembly adjacent to said first strut assembly, said second plurality being such that a respective strut of said second array is connected between each vertex node of a strut assembly of said first array and the respective vertex nodes of each adjacent strut assembly of said first array.

A valuable practical feature of this support frame with its pyramidal strut assemblies is that the dish segments (reflective or conductive) and the pyramidal strut assemblies to which they are to be connected may, if required, be manufactured and assembled as integral demountable units of required reflective or conductive panel rigidity, thus making the overall construction of the antenna more convenient and less expensive.

Embodiments of the present invention will now be described, by way of example only, with reference to the accompanying drawings.

### BRIEF DESCRIPTION OF THE DRAWINGS

FIG. 1 is a partly schematic perspective sketch of a dish antenna, having a dish support frame which is constructed in accordance with the present invention, which has been proposed for the collection of solar energy.

FIG. 2 is a schematic side elevation view of the antenna shown in FIG. 1, with a conventional arrangement for controlling the elevation of the pointing axis of the dish.

FIG. 3 is a schematic side elevation view of the antenna shown in FIG. 1, with an alternative mechanism for controlling the elevation of the pointing axis of the dish.

FIG. 4 is a schematic diagram showing the first array of struts of a support frame constructed in accordance with the present invention.

FIG. 5 is a schematic representation of part of the dish support frame for the antenna shown in FIG. 1, with the rigid rectangular bases of the pyramidal strut assemblies of the support frame corner connected to each other.

FIG. 6 is a schematic representation of part of the dish support frame of the antenna shown in FIGS. 1 and 2, with the rigid rectangular bases of the pyramidal strut assemblies of the dish support frame edge connected to each other.

### DETAILED DESCRIPTION OF THE ILLUSTRATED EMBODIMENTS

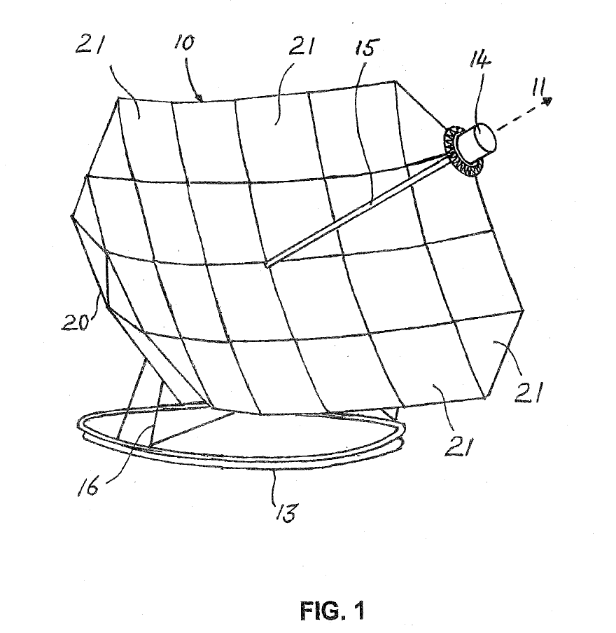

The aperture (area) of the reflective dish 10 of the proposed dish antenna shown in FIGS. 1, 2 and 3 (which has been designed by the present inventor) is of the order of 500 square metres. The dish frame 20 and the dish 10 have a height of 18 metres and a width of 30 metres. The overall aperture shape is rectangular, with clipped corners. It should be appreciated that dishes with smaller and larger apertures than this illustrated embodiment, having other polygonal peripheral shapes, and with corners that are not clipped, may be constructed in accordance with the present invention.

The dish 10 is mounted on a dish support frame 20. A receiver/absorber 14 is mounted at the focal region of the dish 10, at one end of a support strut 15, which (in the illustrated embodiment) is aligned with the pointing axis 11 of the dish 10. The receiver 14, in the case of the antenna design of the present inventor that is shown in FIGS. 1, 2 and 3, comprises a coiled tube in which high quality steam is generated. This steam flows (together with the inlet feedwater) through two rotary joints to the ground, where it is conveyed to the point of use of the steam. The supporting strut 15, which carries the feedwater line, the steam line and a monitoring line, is guyed to the periphery of the dish support frame by four guy lines (not shown in the drawings). This form of receiver can provide steam at temperatures and pressures that can match, and usually exceed, the requirements of any steam turbine. With this type of receiver, the reflective dish elements must be assembled so that the dish produces a chosen, relatively “fuzzy”, focal region, to limit the average solar intensity in the focal region to the safe values which can be tolerated by the materials used in the receiver/absorber 14. (It should be noted, however, that a large dish antenna for collecting solar energy does not have to be used to power a steam turbine; therefore, it may have a different arrangement for utilising the focused energy at the fuzzy focal region of the dish 10.)

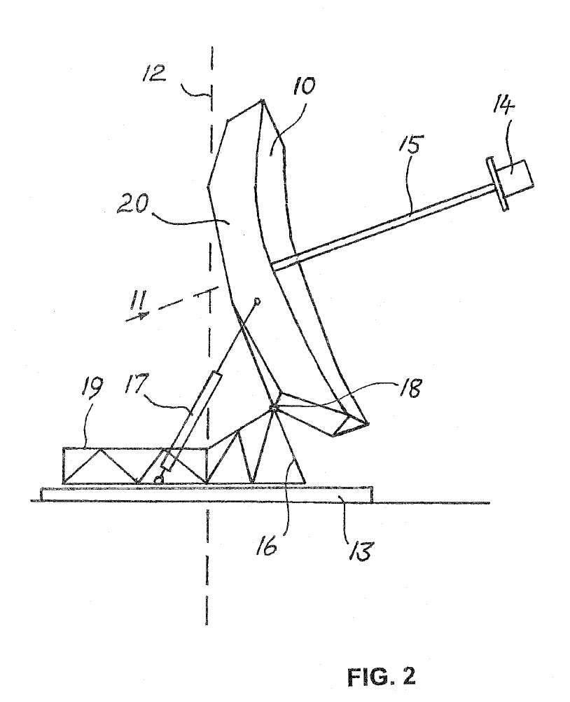

The dish support frame 20 is mounted on the base frame 19 of the antenna, for rotation about a horizontal axis 18. In the FIG. 2 embodiment, control of the elevation of the pointing axis 11 is effected, in a conventional manner, by a hydraulic ram 17 which is connected between the support frame 20 and the base frame 19.

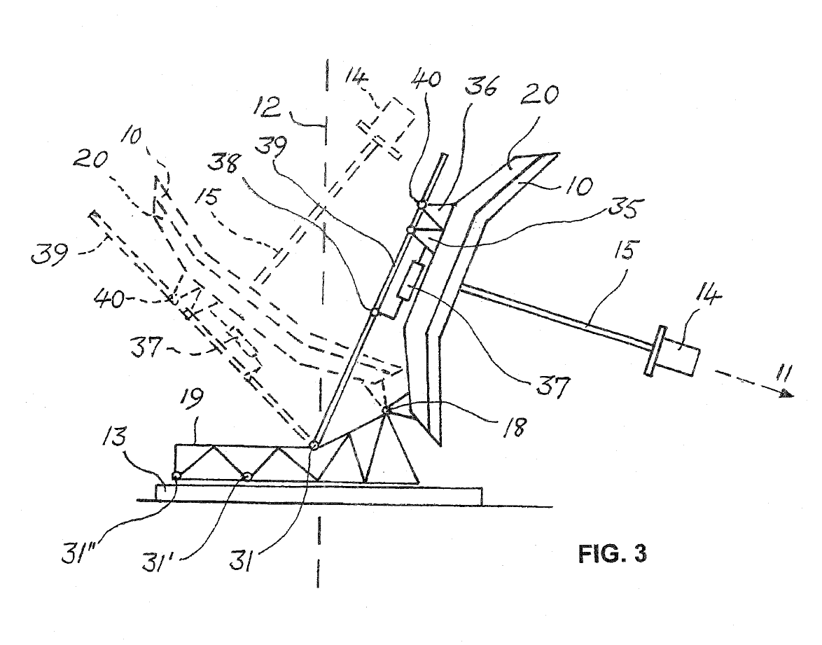

In the FIG. 3 embodiment, the control of the elevation of the pointing axis is effected by a smaller hydraulic ram 37, which has one end connected to a clamp 38 that can be clamped to a beam 39 (typically an I-beam) that is pivotally connected to the base frame 19 at pivot point 31. The other end of the hydraulic ram 37 is connected to a rigid strut or projection 35 extending from the support frame 20 of the dish 10. The end of the projection 35 is mounted on the beam 39 so that it can move along the beam 39 (for example, by an arrangement using wheels which run in the channels which are created one on each side of an I-beam). An additional rigid projection 36, which may be coincident with the projection 35, extends from the support frame 20. The end of the projection 36 which is most remote from the dish 10 is moveable along the beam 39, and is provided with a clamp 40 to enable the projection 36 to be clamped to the beam 39. Actuation of the ram 37 when

(a) the clamp 38 is deactivated (and is clamped to the beam 39), and
(b) the clamp 40 (being activated) is free to move along the beam 39, enables the projections 35 and 36 to be moved along the beam 39, thus altering the angle that the beam 39 makes with the horizontal, and changing the elevation of the pointing axis 11 of the dish. When the ram 37 has completed its extension (or contraction), the clamp 40 is deactivated (that is, clamped to the beam) so that the clamp 38 can be released and the ram 37 can be contracted (or extended) to move the clamp 38 to a new position, from which the elevation of the pointing axis 11 of the dish 10 can be changed by repeating the above procedure.

The advantage of adopting the mechanism shown in FIG. 3 for controlling the elevation of the pointing axis of the dish 10 is that this mechanism can also be used to move the receiver/absorber 14 to a position (shown in FIG. 3) in which it is close to the ground. Here the receiver/absorber 14 is well positioned for servicing.

FIG. 3 also shows two alternative pivot points 31′ and 31″ for the beam 39, on the base frame 19. If the beam 39 is pivoted at 31′, the triangle of forces 31′, 18, 35 is more tolerable than the triangle of forces 31, 18, 35. Moving the pivot point of the beam 39 to 31″, at the end (edge) of the base frame 19, results in a further reduction of the force that has to be exerted by the ram 37 to change the pointing axis 11 of the dish 10.

Whether the mechanism shown in FIG. 2 or FIG. 3 (or another elevation control mechanism) is adopted to control the elevation of the pointing axis 11 of the dish 10, the base frame 19 is mounted on a circular base 13. To enable the pointing axis 11 to track the sun using the azimuth/altitude technique, the base frame 19 is rotatable about a vertical axis 12, at the centre of a mounting base 13, preferably using the rotation apparatus described in the specification of the present inventor's International patent application No. PCT/AU2004/001474 (which is WIPO Publication No. WO 2005/043671 A1). That specification also describes a clamp construction that may be used for the clamps 38 and 40. With that construction, the clamp is spring-biased to grip, firmly, an I-beam when the clamp has not been activated. Upon activation, the clamp is released from the I-beam.

The dish 10 of FIG. 1 is shown as constructed of individual reflective elements 21 each (except at the corners of the dish) comprising a square curvilinear surface, held rigid by a substrate. The dish could be made up of elements which are different in both shape and size. However, as indicated above, economy of manufacture in a factory and ease of assembly on the site of the antenna are achieved by forming elements of the dish surface and its supporting substrate into rectangular panels, which are each connected to the base nodes of pyramidal strut assemblies of the support frame 20.

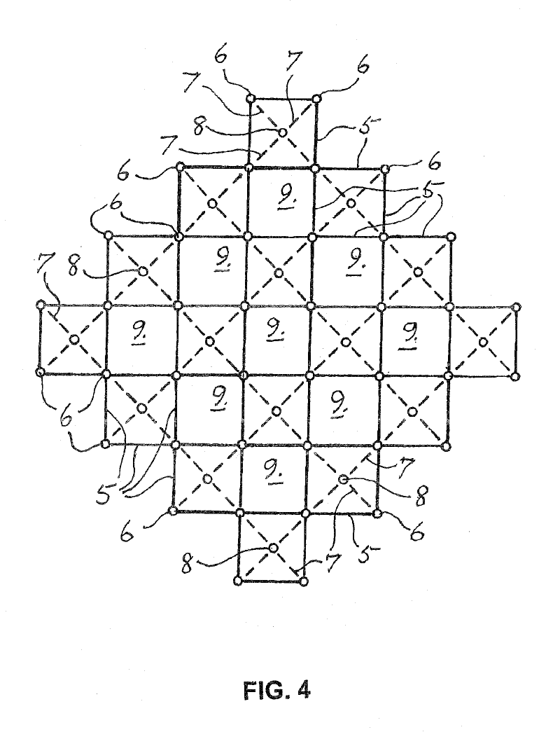

FIG. 4 is a schematic diagram of the first array of struts in a support frame for a dish having a polygonal shape that is approximately a circle. The first array of struts in FIG. 4 is shown as if it is viewed along the pointing axis of the dish. As will be apparent, this array of struts has sixteen pyramidal strut assemblies. This array of struts, therefore, is symbolic, for the dish it will support will be a small dish. The present invention is able—and is intended—to support large dishes, with a support frame having significantly more than sixteen pyramidal strut assemblies in its first array of struts.

Referring to FIG. 4, each pyramidal strut assembly has four base struts 5, connected to four base nodes 6 in a manner that ensures that they form a rigid rectangular base. [It should be appreciated that a rectangular combination of four rigid struts and four connecting nodes does not inherently produce a rigid base. It is necessary to assemble these eight components so that do form a rigid, and therefore stable, rectangular base. Any one of a number of conventional engineering techniques may be used to ensure that the rectagular bases of the pyramidal strut assemblies are rigid.] Four other struts 7 extend from respective base nodes 6 to a vertex node 8. The rigid base of each pyramidal strut assembly is corner connected to the rigid base of an adjacent pyramidal strut assembly.

The second array of struts of the support frame (not shown in FIG. 4) comprises a layer of struts which inter-connect the vertex nodes 8. The combination of the first array of struts and the second array of struts forms the support frame for a dish. The base nodes 6 are located on a curvilinear envelope, and establish the mounting points for the reflective or conductive elements which—when mounted on their mounting points, form the dish of the dish antenna. (Some of the base nodes may include an offset or protrusion, which constitutes its mounting point.) The act of mounting the reflective or conductive elements of the dish on the support frame provides further stiffness and rigidity to the support frame.

If additional rigidity is required, additional pyramidal strut assemblies may be formed in the nine “spaces” 9 between the corner connected pyramidal strut assemblies. As should be clear from FIG. 4, at the level of the bases of the pyramidal strut assemblies, each of those nine spaces is surrounded by four base struts, positioned as a rectangle. Therefore, each additional pyramidal strut assembly will be formed by including four additional struts in each space 9. Each additional strut will have one end connected to a respective base node 6, and its other end connected to an additional vertex node. The additional vertex node will be positioned on the same curvilinear envelope as the vertex nodes 8, and at least one (preferably, at least two) additional struts will be added to the second array of struts to connect the additional vertex node to the second array of struts.

It should be apparent that each time an additional pyramidal strut assembly has been added to a “space” 9, the base of that pyramidal strut assembly (a) will be a rigid, rectangular base, and (b) will be edge connected to the rigid bases of four of the “original” corner connected pyramidal strut assemblies.

When an additional pyramidal strut assembly has been added to each of the nine “spaces” 9, and their extra vertex nodes have been locked into the second array of struts, the bases of all of the pyramidal strut assemblies will be edge connected to the base struts of each adjacent pyramidal strut assembly. This is the most rigid (and the strongest) form of the first array of a support frame for a dish that can be constructed in accordance with the present invention.

When adding extra pyramidal strut assemblies to the spaces 9 between the corner connected pyramidal strut assemblies, it is preferable to add those extra pyramidal strut assemblies to the edge regions of the support frame, to strengthen the periphery of the support frame.

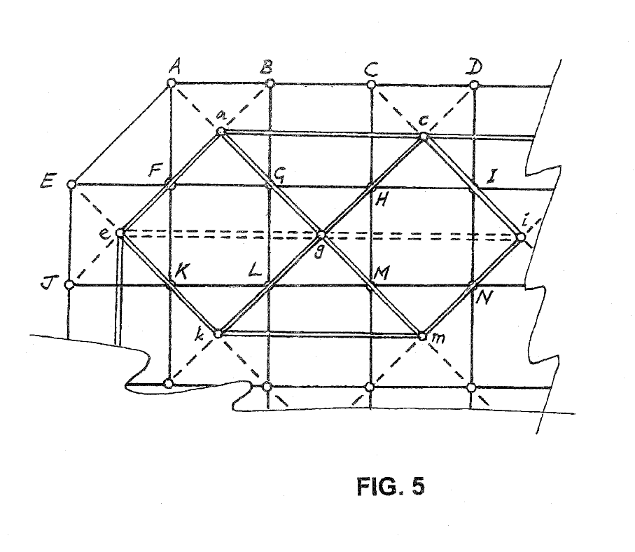

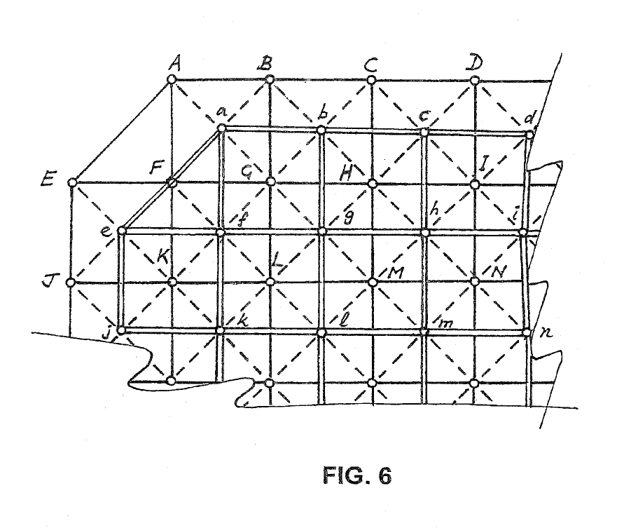

The peripheral shape of the parabolic reflecting dish of the solar energy collector antenna shown in FIG. 1 is essentially rectangular, with clipped corners. Two forms of support frame structures for that dish are depicted in FIGS. 5 and 6.

Referring to the support frame structure shown, in part, in FIG. 3, the support frame 20 has a layer of struts, including struts AB, BC, CD, AF, BG, CH, DI, FG, GH, HI, FK, GL, HM, IN, KL, LM and MN, which are connected to base nodes A, B, C, D, F, G, H, I, K, L, M and N. These nodes are conventional nodes, in the form of generally spherical members on which planar surfaces are formed. The planar surfaces of each node are adapted to receive the ends of the struts, which are rigidly attached to the node. Typically, the attachment to a node is achieved by a threaded extension of the strut being screwed into a correspondingly threaded bore in the node.

The base nodes A, B, C, D, F, G, H, I, K, L, M and N are also mounting points for the dish segments. By carefully choosing the lengths of the struts of the dish support frame, the support frame can be constructed so that the base nodes (or their offsets or protrusions) lie on the envelope of the required dish surface which, in the case of a solar energy collection antenna of the type shown in FIGS. 1 and 2, is a paraboloidal surface (or a surface which is essentially the cap of a sphere). It should be noted that, because the dish has a large aperture, there is only a slight curvature of the surface of any reflective or conductive segment or element.

Thus the base nodes of the illustrated support frame of FIG. 5 (including the base nodes A, B, C, D, F, G, H, I, K, L, M and N) and their interconnecting struts (AB, BC, CD, AF, BG, CH, DI, FG, GH, HI, FK, GL, HM, IN, KL, LM and MN) form a layer of rigid, substantially square or rectangular (a square is a special case of a rectangle) structures which carry the dish 10. In addition, these rectangular structures form the rectangular bases of respective pyramidal strut assemblies. To complete the pyramidal strut assemblies, the vertex nodes a, c, e, g, i, k, and m are connected to their four associated base nodes by struts aA, aB, aG and aF; cC, cD, cI and cH; eE, eF, eK and eJ; and so on. The dish 10 of the antenna, therefore, is connected to an array of pyramidal strut assemblies, with each strut assembly (a) having eight struts, four base nodes and a vertex node, and (b) being corner connected, at its base, to each adjacent strut assembly.

The remainder of the support frame 20 comprises a second array of struts, namely, the layer of rigid struts ac, ae, ag, cg, ci, ek, gk, gm and so on, which interconnect the vertex nodes a, c, e, g, i, k, and m.

Referring now to the support frame structure shown, in part, in FIG. 6, the support frame 20 has a first array of struts which includes a layer of struts AB, BC, CD, AF, BG, CH, DI, FG, GH, HI, FK, GL, HM, IN, KL, LM and MN, which are connected to base nodes A, B, C, D, F, G, H, I, K, L, M and N. As noted already, the base nodes A, B, C, D, F, G, H, I, K, L, M and N also provide mounting points for the dish segments 21.

The base nodes A, B, C, D, F, G, H, I, K, L, M and N and their interconnecting struts AB, BC, CD, AF, BG, CH, DI, FG, GH, HI, FK, GL, HM, IN, KL, LM and MN form a layer of rigid, substantially square or rectangular structures which carry the dish 10. (Note that the support frame of FIG. 6 has the same number of rigid rectangular structures in the first array of struts as the support frame of FIG. 5.) These rectangular structures form the rectangular bases of respective pyramidal strut assemblies which constitute the remainder of the first array of struts of the support frame. To complete the pyramidal strut assemblies, the vertex nodes a, b, c, d, e, f, g, h, i, j, k, l, and m are connected to their four associated base nodes by struts aA, aB, aG and aF; bB, bC, bH and bG; cC, cD, cI and cH; eE, eF, eK and eJ; and so on. The dish 10 of the antenna, therefore, is connected to an array of pyramidal strut assemblies, with each strut assembly (a) having eight struts, four base nodes and a vertex node, and (b) being edge connected, at its base, to each adjacent strut assembly.

The remainder of the support frame 20 comprises a second array of struts, namely, the layer of rigid struts ab, bc, cd, af, bg, ch, di, fg, gh, hi, and so on, which interconnect the vertex nodes a, b, c, d, e, f, g, h, i, j, k, l, and m. Note that, except at the corners of the dish, the second array of struts does not normally interconnect the vertex nodes of diagonally adjacent pyramidal strut assemblies.

A feature of the support frame of FIG. 6 is that, with a regular array of m×n pyramidal strut assemblies, and with no missing strut assembly, the resultant structure is essentially two interlocking arrays of pyramidal strut assemblies, with offset vertex nodes and shared rigid struts connecting the respective bases to their vertex nodes. This is a very strong and rigid structure, which is the preferred structure to be adopted when high wind loads on the dish can be expected.

Thus the preferred arrangement is for the first array of struts of the present invention to be a regular m×n array of pyramidal strut assemblies with no gaps or spaces in the array, and with the rigid rectangular base of each pyramidal strut assembly being edge connected to the bases of all of its adjacent pyramidal strut assemblies.

The distance between each of the bases of the pyramidal strut assemblies of the first array of struts and their respective vertex nodes determines the spacing between the dish (when mounted on the first array of struts) and the second array of struts. As noted earlier in this specification, this distance influences the frame strength and rigidity of the dish support, and hence the accuracy and rigidity of the dish itself. While the nodes of the rectangular bases of the first array of the dish of the antenna shown in FIGS. 1 and 2 define a curvilinear surface which is paraboloidal (or the cap of a sphere), thus ensuring the correct shape for the dish itself, there is no mandatory requirement that the vertex nodes of the first array of struts define any particular surface. Conveniently, the layer of struts of the second array could have a shape that is essentially parabolic, or approximately the cap of a sphere, provided the spacing between the bases of the first array and the layer of struts of the second array is adequate to satisfy strength and rigidity requirements for the overall dish support frame structure. However, engineering constraints on the way in which the dish and its support frame are mounted on the base frame of an antenna may mean that the struts of the second array do not lie in the envelope of a curvilinear surface.

Another design criterion which can, with advantage, be implemented is to ensure that as many as practicable of the rigid struts of the dish support frame are of equal length, and preferably of equal strength. Employing this design approach can result in (a) manufacturing cost economy, and (b) all the rigid struts joining the vertex nodes to the base nodes of the pyramidal structures making up the first array having the same length.

Whatever the selected curvilinear nature of the second array, there should be established, within this second array of rigid struts, an obvious group of rectangular assemblies of four struts. Each such rectangular assembly of four struts can be constructed (using conventional engineering techniques) as a rigid rectangular assembly, akin to the rigid rectangular bases of the pyramidal strut assemblies of the first array. As also noted earlier in this specification, the inclusion of rigid rectangular assemblies of four struts in the second array of struts does improve the overall dish support frame rigidity. (Alternatively, it can result in some struts being lighter and thus make the overall construction more economical.)

The strongest form of dish support frame requires a first array in which all the possible additional or “infill” pyramidal strut assemblies are present, and a second array comprising a plurality of rigid rectangular assemblies of four struts, as shown in FIG. 6. When designing a dish support frame, the inclusion of infill pyramidal strut assemblies will normally be considered not only for strengthening purposes, but also to provide an increased “factor of safety”, and/or to enable selected struts to be reduced in strength (and therefore cost) without jeopardising the intended design strength of the dish support frame structure.

Thus the design process for dish support frames, having a specified rigidity, chosen from a minimum to a maximum, involves the following steps:
(a) The first array of rigid struts is designed as an array of pyramidal strut assemblies, each having a rigid base. The bases of these strut assemblies are exclusively corner connected, with no rigid rectangular strut assembly in the second array of struts.
(b) Increasing numbers of infill pyramidal strut assemblies are included in the first array of struts, with no rigid rectangular strut assembly in the second array of struts.
(c) All possible infill sites of the first array contain an additional pyramidal strut assembly, so that the rectangular bases of first array of struts are all edge connected to each other. No rigid rectangular strut assembly is included in the second array of struts.
(d) To each of steps (a), (b) and (c), an increasing number of rigid rectangular strut assemblies is included in the second array of struts, until, in the limit, the second array of struts consists exclusively of rigid rectangular strut assemblies.

The support frame created by implementing step (c) with the second array of struts consisting exclusively of rigid rectangular strut assemblies, as shown in FIG. 6, is the strongest form of support frame that can be constructed in accordance with the present invention.

The large aperture dish antennas shown in FIGS. 1, 2 and 3 include the support frame of the present invention. They also have other beneficial antenna design features. Those other features include the dish aperture shape and the position, relative to the dish, of the horizontal axis 18.

When mounting a dish support frame on a base frame of an antenna, it is preferable for the elevation tilt axis of the dish to be located between the central portion of the dish support frame and the outermost ends of the strut assemblies of the dish support frame (that is, at a location beneath the dish of the antenna, intermediate between the centre of the dish and its periphery). This feature allows the total height of the antenna, when pointing vertically upwards, to be less than the total height of a conventional dish antenna of the same size and aperture shape, but with its horizontal tilt axis located on the dish centreline and arranged with its pointing axis (line of sight) vertical. The tilt axis could be outside the edge of the dish support frame, although it is believed that a tilt axis in such a location will rarely be required.

With regard to the dish aperture shape, the support frame of the present invention permits the construction of effective dish antennas to be built with apertures ranging from a few tens of square metres to many hundreds of square metres; and potentially to two thousand, five hundred square metres or more. The limiting factors on size are the expected maximum wind velocities for the site of the antenna, the total wind loading on the dish and the overall cost. Most conventional dish antennas have a circular or polygonal aperture shape. The preferred shape of the aperture of the dish supported by the support frame of the present invention is one in which the height above the ground of the top of the dish, measured when the pointing axis of the dish is horizontal, is less than its width. The shape is preferably rectangular, with a height to width ratio of the order of 2:3, and with optional clipped corners.

The lesser height of the dish and its greater width, combined with the location of the horizontal tilt axis 18 between the dish centre and the lower rim edge of the dish, has advantages, when compared with a dish having a circular or polygonal aperture, including:
a) the shape of the illustrated dish results in a general reduction of the wind loading on the antenna;
b) in an array of solar energy collection antennas, there is a reduction of the shading of dish antennas in the array at early morning and late afternoon; and
c) the ability to rotate the dish about its horizontal tilt axis 18 so that the receiver 14 mounted on the antenna, can be moved to ground level to facilitate access to the receiver.

As noted previously, the antenna shown in FIG. 1 has the facility to track the sun. Control of the tracking operation is established technology. Preferably, angular position transducers on the azimuth and altitude axes provide signals to be compared with information from a computer representation of the position of the illuminating source at each instant, and its requirement for specific angular positions of each dish antenna axis. If the two positions are not the same, the control system adjusts the position of the pointing axis of the dish to make them coincident.

Engineers and other persons who work in this field will appreciate that the support frame constructions shown in FIGS. 4, 5 and 6, and the antennas shown in FIGS. 1, 2 and 3, represent examples of the present invention and the way in which it may be used. It is emphasised that the support frame is not limited in its use to solar energy collectors, or to antennas of the type shown in FIGS. 1, 2 and 3. Variations to and modifications of the embodiments described above may be made without departing from the present inventive concept, as defined by the following claims.

1. A support frame for a dish of a dish antenna, said support frame comprising a first array of rigid struts and a second array of rigid struts, characterised in that:
(1) said first array comprises a first plurality of rigid strut assemblies, each of said strut assemblies consisting of eight struts, connected at their ends to five nodes; said five nodes consisting of four base nodes and a vertex node; each of said strut assemblies comprising a pyramidal assembly having
(a) a rigid rectangular base comprising four of said eight struts connected to said four base nodes, said base nodes being at the corners of said rectangular base; said four base nodes comprising mounting points for said dish; and
(b) each of the other four struts having one end connected to a respective base node and the other end thereof connected to said vertex node; said vertex node being spaced apart from its associated rectangular base;
(2) the base of each strut assembly of said first array is corner connected to the base of each adjacent strut assembly of said first array, said corner connection of the bases of two adjacent strut assemblies being effected by one corner base node of the first of said two strut assemblies being also one corner base node of the second of said two strut assemblies; and
(3) said second array comprises a second plurality of rigid struts in a single layer, each strut of said second array being connected between a vertex node of a pyramidal strut assembly of said first array and the vertex node of an adjacent pyramidal strut assembly.

2. A dish support frame as defined in claim 1, including at least one additional pyramidal strut assembly in a respective space between the pyramidal strut assemblies of the corner connected pyramidal strut assemblies; said (or each) additional strut assembly comprising four additional struts; one end of each additional strut being connected to a respective corner base node of a pyramidal strut assembly; the other end of each additional strut being connected to an extra vertex node; said extra vertex node being positioned in said layer of struts of said second array; at least one additional strut being included in said second array to connect said extra vertex node to said second array of struts.

3. A support frame for a dish of a dish antenna, said support frame comprising a first array of rigid struts and a second array of rigid struts, characterised in that:
(1) said first array comprises a first plurality of rigid strut assemblies, each of said strut assemblies consisting of eight struts, connected at their ends to five nodes; said five nodes consisting of four base nodes and a vertex node; each of said strut assemblies comprising a pyramidal assembly having
(a) a rigid rectangular base comprising four of said eight struts connected to said four base nodes, said base nodes being at the corners of said rectangular base; said four base nodes comprising mounting points for said dish; and each of the other four struts having one end connected to a respective base node and the other end thereof connected to said vertex node; said vertex node being spaced apart from said rectangular base;
(2) the base of each strut assembly of said first array is edge connected to the base of each adjacent strut assembly of said first array, said edge connection of the bases of two adjacent strut assemblies being effected by one side strut of the base of a pyramidal strut assembly being also a side strut of the base of the adjacent pyramidal strut assembly, and the base nodes at the ends of said one side strut the first of said adjacent strut assemblies being also the base nodes at the ends of said one side strut of the second of said adjacent strut assemblies; and
(3) said second array comprises a second plurality of rigid struts in a single layer, each strut of said second array being connected between a vertex node of a first strut assembly of said first array and the vertex node of a strut assembly adjacent to said first strut assembly, said second plurality being such that a respective strut of said second array is connected between each vertex node of a strut assembly of said first array and the respective vertex nodes of each adjacent strut assembly of said first array.

4. A dish support frame as defined in claim 1, further characterised in that said second array of struts includes at least one rectangular assembly of four struts of said second array.

5. A dish support frame as defined in claim 4, in which said at least one rectangular assembly of four struts of said second array is a rigid assembly.

6. A dish support frame as defined in claim 3, in which the struts of said second array of struts are formed as rigid rectangular assemblies of four struts, thereby creating a dish support frame comprising two interlocking arrays of pyramidal strut assemblies, with offset vertex nodes and shared rigid struts connecting the respective bases to their vertex nodes.

7. A dish support frame as defined in claim 1, in which at least one of said base nodes of said first array has a protrusion therefrom which forms the mounting point of said at least one base node.

8. A dish support frame as defined in claim 1, further characterised in that a plurality of reflecting or conductive dish elements are mounted on said mounting points of said base nodes to form said dish.

9. An antenna comprising a support frame as defined in claim 8, mounted on a base frame; said dish having a pointing axis; further characterised in that
(a) said antenna includes means operatively associated with said base frame and said support frame for varying the elevation of said pointing axis, and
(b) said base frame is rotatable about a vertical axis.

10. An antenna as defined in claim 9, in which said means for varying the elevation of said pointing axis comprises means for rotating said dish support frame about a horizontal axis; said horizontal axis being located on said base frame, between the central region of said support frame and the edge of said support frame.

11. An antenna as defined in claim 9, in which the aperture of said dish has a polygonal periphery.

12. An antenna as defined in claim 11, in which (a) the aperture of said dish is essentially rectangular, with substantially horizontal top and bottom edges, and (b) the height of the top of the dish, above the ground, when the pointing axis of the dish is horizontal, is less than the width of said dish aperture.

13. An antenna as defined in claim 12, in which the ratio of said height to said width is of the order of 2:3.

14. (canceled)

15. (canceled)
